(19) United States
(12) Patent Application Publication
(10) Pub. No.: US 2024/0037390 A1
(43) Pub. Date: Feb. 1, 2024

(54) Method and Apparatus for Weight-Sharing Neural Network with Stochastic Architectures

(71) Applicants: Robert Bosch GmbH, Stuttgart (DE); Tsinghua University, Beijing (CN)

(72) Inventors: Jun Zhu, Beijing (CN); Zhijie Deng, Beijing (CN); Yinpeng Dong, Beijing (CN); Chao Zhang, Shanghai (CN); Kevin Yang, Shanghai (CN)

(21) Appl. No.: 18/249,162

(22) PCT Filed: Oct. 15, 2020
(86) PCT No.: PCT/CN2020/121170

§ 371 Date: Apr. 14, 2023

(51) Int. Cl. G06N 3/08; G06N 3/047

(52) U.S. Cl. CPC G06N 3/08; G06N 3/047

(57) ABSTRACT

A method for training a weight-sharing neural network with stochastic architectures is disclosed. The method includes (i) selecting a mini-batch from a plurality of mini-batches, a training data set for a task being grouped into the plurality of mini-batches and each of the plurality of mini-batches comprising a plurality of instances: (ii) stochastically selecting a plurality of network architectures of the neural network for the selected mini-batch; (iii) obtaining a loss for each instance of the selected mini-batch by applying the instance to one of the plurality of network architectures; and (iv) updating shared weights of the neural network based on the loss for each instance of the selected mini-batch.

### FIELD

Aspects of the present disclosure relate generally to artificial intelligence, and more particularly, to a training method and an inference method for a weight sharing neural network with stochastic architectures.

### BACKGROUND

Deep neural networks (DNNs) are widely used to process complex data in a wide range of practical scenarios. Conventionally designing a DNN for performing a particular machine learning task is a labor-intensive process that requires a large amount of trial and error by experts, in which experts needs to manually optimize the architecture of the DNN during the iterations of training and testing processes.

Neural architecture search (NAS) technique has been proposed to automatically search for neural network architectures in order to relieve human labor. However the NAS technique in early time typically requires to train thousands of models from scratch and are incredibly computing recourse intensive, making it difficult to implement in practice.

There have proposed several methods for the automatic search of network architectures while reducing the computing requirement. One promising method is sharing weights among network architectures, rather than training thousands of separate network architecture models from scratch. Particularly, one weight sharing neural network capable of emulating any network architecture thereof may be trained. Different network architectures of the neural network are different subsets of the neural network, and shares the weights contained in the neural network.

There needs enhancement for improving the performance of the weight sharing technique.

### SUMMARY

According to an embodiment, there provides a method for training a weight-sharing neural network with stochastic architectures. The method comprises: selecting a mini-batch from a plurality of mini-batches, a training data set for a task being grouped into the plurality of mini-batches and each of the plurality of mini-batches comprising a plurality of instances; stochastically selecting a plurality of network architectures of the neural network for the selected mini-batch; obtaining a loss for each instance of the selected mini-batch by applying the instance to one of the plurality of network architectures; and updating shared weights of the neural network based on the loss for each instance of the selected mini-batch.

According to an embodiment, there provides a method for inferencing by using a weight-sharing neural network. The method comprises: receiving an input data; randomly selecting one or more network architectures of the neural network; inferring one or more output data by the selected one or more network architectures respectively based on the input data; and obtaining a final inference data based on the one or more output data.

By using the training method of the disclosure, the diversity of the weight sharing neural network with stochastic architectures can be explored to enhance the performance of the weight sharing network model. On the other hand, by using the inferencing method of the disclosure, the diversity of the weight sharing neural network with stochastic architectures can be explored in inference process to enhance the protection of network architectures from being attacked. Other advantages of the disclosure would be explained in the following description.

### BRIEF DESCRIPTION OF THE DRAWINGS

The disclosed aspects will hereinafter be described in connection with the appended drawings that are provided to illustrate and not to limit the disclosed aspects.

FIG. 1 illustrates an exemplary weight sharing neural network with stochastic architectures (NSA) according to an embodiment.

FIG. 2 illustrates an exemplary method for training a weight sharing NSA according to an embodiment.

FIG. 3 illustrates an exemplary method for inferencing with a weight sharing NSA according to an embodiment.

FIG. 4 illustrates a graph comparing the accuracy and loss between training and testing according to an embodiment.

FIG. 5 illustrates an exemplary method for training a weight sharing NSA according to an embodiment.

FIG. 6 illustrates a graph comparing the accuracy and loss between training and testing according to an embodiment.

FIG. 7 illustrates an exemplary method for training a weight sharing NSA according to an embodiment.

FIG. 8 illustrates an exemplary computing system according to an embodiment.

### DETAILED DESCRIPTION

The present disclosure will now be discussed with reference to several example implementations. It is to be understood that these implementations are discussed only for enabling those skilled in the art to better understand and thus implement the embodiments of the present disclosure, rather than suggesting any limitations on the scope of the present disclosure.

The present disclosure describes a method and a system, implemented as computer programs executed on one or more computers, which provide a task neural network configured to perform a particular machine learning task. The task neural network is implemented as a weight-sharing neural network with stochastic architectures. As an example, the particular machine learning task may be a machine learning image processing task. As another example, the particular machine learning task can be to classify the resource or document. As another example, the particular machine learning task can be to score a likelihood that a particular advertisement will be clicked on. As another example, the particular machine learning task can be to score a likelihood that a user will favorably respond to a recommendation. As another example, the particular machine learning task may be language translation. As another example, the particular machine learning task may be an audio processing task. As another example, the particular task can be a health prediction task. As another example, the particular task can be an agent control task carried out in a control system for automatic driving, a control system for an industrial facility, or the like.

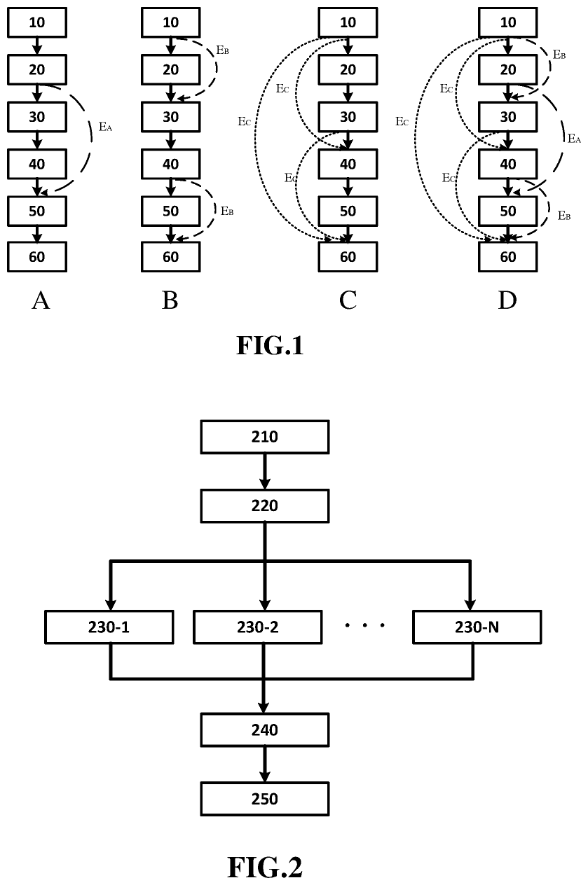

FIG. 1 illustrates an exemplary weight sharing NSA (Network with Stochastic Architectures) according to an embodiment.

A weight sharing NSA may be defined as a neural network having a fixed set of weights and stochastically sampled architectures in training process and/or inference processes, distinct from the regular DNNs.

As shown in FIG. 1, label 10 denotes an input node, in which input data are received by the neural network. The input data may be processed if necessary, for example, may be projected to feature maps in a latency semantic space. Each of labels 20-50 denotes an operation node which includes at least one operation. For example, each of the node 20-50 may include a convolution operation in the case of CNN network. Label 60 denotes an output node, in which for example output data are provided by the neural network. The data to output may be processed if necessary, for example, the feature maps in the latency semantic space may be projected to user recognizable output data. The nodes 10-60 are also referred to as layers or modules.

Three exemplary network architectures A to C and a weight sharing NSA D including the three network architectures A to C are illustrated in FIG. 1. Each of the network architectures A to C includes a set of operation nodes 10-60 and an edge pattern, in which each edge connecting two nodes. Particularly, the network architecture A includes nodes 10-60, edges connecting the nodes 10-60 in series, and an edge E_{A} connecting two nodes 20 and 50. The network architecture B includes the nodes 10-60, the edges connecting the nodes 10-60 in series, and two edge E_{B} connecting a pair of nodes 10, 30 and a pair of nodes 40, 60 respectively. The network architecture C includes the nodes 10-60, the edges connecting the nodes 10-60 in series, and three edge E_{C} connecting a pair of nodes 10, 40, a pair of nodes 30, 60 and a pair of nodes 10, 60 respectively. The edges E_{A}, E_{B}, E_{C} connecting nonadjacent nodes may be referred to as bypass edges. All the nodes connected in series may be referred to as main chain. Each of the network architectures A to C is a subset of the NSA D, which includes diverse architectures A to C as shown in FIG. 1. Therefore the architectures A to C may share the weights of the NSA D, for example, the weights related to the operations included in the nodes, and the weights for the edges.

In a wiring view, different network architectures such as architectures A to C activate different skip-connection patterns among a fixed number of computational operations, the different skip-connection patterns are represented by the edges. Each network architecture such as A to C is represented as a directed graph of nodes connected by edges. It is appreciated that the directed graph of operation nodes representing a network architecture may be parameterized as a discrete adjacency matrix.

It is appreciated that the structure of the NSA D in FIG. 1 is illustrative, a NSA D may include much more architectures, such as hundreds, thousands, tens of thousands or more architectures. And the structure of a NSA and accordingly the structure of a network architecture of the NSA may be much more complex, for example, the NSA may includes more nodes than shown in FIG. 1, and the operations represented by the node 20-50 may include any appropriate operations for performing a task, and the disclosure is not limited to specific operations of the NSA.

FIG. 2 illustrates an exemplary method for training a weight sharing NSA according to an embodiment.

Before carrying out the training method of FIG. 2, a network architecture space may be set up. As an example, an architecture space similar to the NSA D in FIG. 1 may be set up. In this example, the architecture space includes six nodes, which are connected in series, and bypass edges each connecting any two nonadjacent nodes. Given a possible network architecture in the architecture space is represented as a directed graph of operation nodes, there may be 1023 possible network architectures in this architecture space, in other words, the size of the architecture space is 1023. It is appreciated that, if it is not required to have a main chain, which includes all the nodes connected in series, in the architecture space, the size of the architecture space would be larger.

In an embodiment, a neural network may be designed to represent an architecture space. The neural network may be divided into 3 stages, each stage may include 8 convolution modules. In this embodiment, each stage may be of the similar structure as the NSA D as discussed above. A sub-architecture may be sampled from each stage, and therefore an architecture may be sampled by connecting the three sub-architectures. As an example, wide convolutions with a widening factor (for example, the widening factor is 10 or the like) for feature extraction may be used in the nodes. A uniform sum may precede each convolution module to aggregate incoming feature maps, and a batch normalization (BN) may follow the convolution module, i.e., a ReLU-Convolution-BN triplet may be included in each of at least part of the nodes.

It is appreciated that the size of the whole architecture space as discussed above would be huge. In an embodiment, a refinement of the architecture space may be performed, in which a subset of architectures may be sampled from the whole architecture space. For example, to avoid meaningless architecture samples, a knowledge guided sampler, such as the Erdos-Renyi (ER) model (Refer to Saining Xie, Alexander Kirillov, Ross Girshick, and Kaiming He. Exploring randomly wired neural networks for image recognition. In Proceedings of the IEEE International Conference on Computer Vision, 460 pages 1284-1293, 2019) may be used to sample the subset of architectures from the whole architecture space, for example, the sampler with 0.3 probability to activate any one of the possible skip-connection patterns may be used to sample the architectures. As an example, a number of 500 architectures may be sampled with the sampler to form the refined architecture space. It is appreciated that the size of the refined architecture space is not limited to a specific number, for example, the size may be 500, 5000, 50000 or other numbers. The weight sharing NSA may be the refined architecture space including the sampled network architectures. The weight sharing NSA may also be the whole architecture space in some embodiments. It is appreciated that the weight sharing NSA may be represented by a set of weights contained therein.

The training data set may be divided into a plurality of mini-batches, each mini-batch contains a plurality of instances. For example, the training data set are divided into M mini-batches, each mini-batch contains N training data instances. The size of the NSA is S, that is, the NSA representing the refined architecture space includes S network architectures. In an embodiment, S is no less than 500. In an embodiment, S is no less than 500 and no larger than 5000. The weights of NSA may be initialized in any suitable way, for example, all of the weights may be initialized to be 1, or any of the weights may be initialized to be a random number.

At step 210, one mini-batch is selected from the plurality of mini-batches, for example, one mini-batch is selected randomly from the M mini-batches, and the selected mini-batch includes N instances of training data.

At step 220, one network architecture is selected from the NSA for the selected mini-batch. For example, one network architecture A is randomly sampled from the S architectures of the NSA with a distribution P(A). In the exemplary NSA as discussed above, the randomly selected network architecture A includes 24 operation nodes connected in series and a set of bypass edges, each node including a ReLU-Convolution-BN operation triplet.

At step 230-1, a first one of the N instances of the selected mini-batch is applied to the selected network architecture A to obtain a loss value. Similarly, at steps 230-2 to 230-N, each of the second instance to the Nth instance of the selected mini-batch is applied to the selected network architecture A to obtain a loss value. The loss value for one instance may be formulated as:

L=−log p(yᵢ|xᵢ;W,A),A˜p(A) (1)

where W denotes the weights contained in the network architecture, (xᵢ, yᵢ) denotes the instance of training data, for example, xᵢ denotes the data inputted to the network architecture, yᵢ denotes the data that is expected to be outputted by the network architecture. p(yᵢ|xᵢ; W, A) is the predictive distribution, from which the loss value L=−log p(yᵢ|xᵢ; W, A) is obtained. It is appreciated that although steps 230-1 to 230-N are illustrated as parallel processes, these steps can also be performed in one or more loops in which the steps are performed one by one.

At step 240, the N loss values for the N instances of the selected mini-batch are averaged to obtain a mean loss value over the mini-batch. Then mean loss value for one mini-batch may be formulated as:

$$L = \frac{1}{\vert B \vert} {\sum }_{( {x}_{i} , {y}_{i} ) ∈ B} - log p ( {y}_{i} \vert {x}_{i} ; W , A ) , A ∼ p ( A ) \qquad ( 2 )$$

where B denotes the selected mini-batch of training data, |B| denotes the number of instances included in the mini-batch, in this example |B| equals to N.

At step 250, the weights of the selected network architecture are updated based on the mean loss. Accordingly, the shared weights of the NSA are updated. For example, gradients for the weights may be calculated by back propagating the mean loss for the mini-batch along the selected network architecture, and accordingly the weights of the selected network architecture are updated using the gradients. The shared weights of the selected network architecture include the weights for the operations contained in the network architecture and the weights for the edges contained in the network architecture. In the example that the ReLU-Convolution-BN operation triplet is used in the nodes, the shared weights include the weights for the convolution operations and the weights for the BN operations. The weights for the edges may be referred to as summation weights.

Then the process of steps 210-250 may be repeated for another mini-batch selected from the M mini-batches. The process of steps 210-250 may be repeated for M times for the M mini-batches of the training data set. The procedure for traversing the training data set by repeating the process of steps 210-250 for the M times may be referred to as an epoch. A plurality of epochs may be performed for the training data set until a convergence condition is obtained. For example, the convergence condition may be that the loss value is stable to be under a threshold.

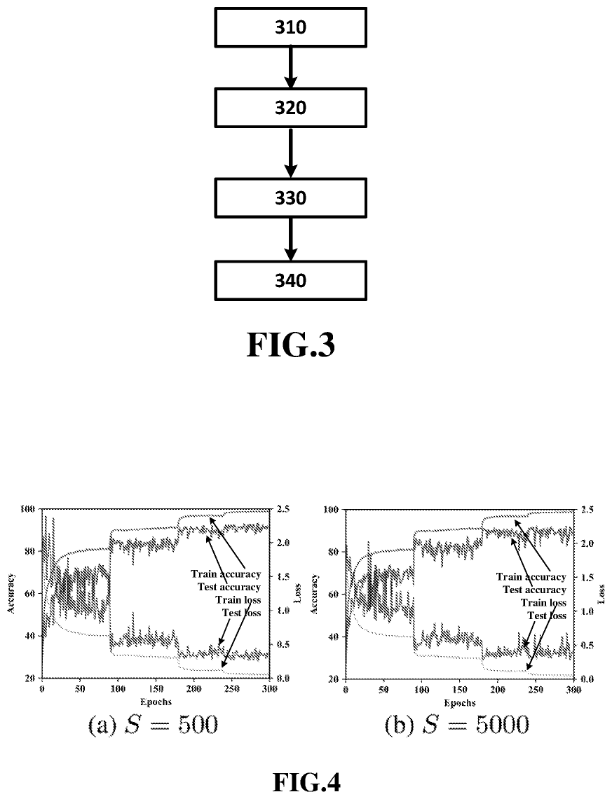

FIG. 3 illustrate an exemplary method for inferencing with a weight sharing NSA according to an embodiment.

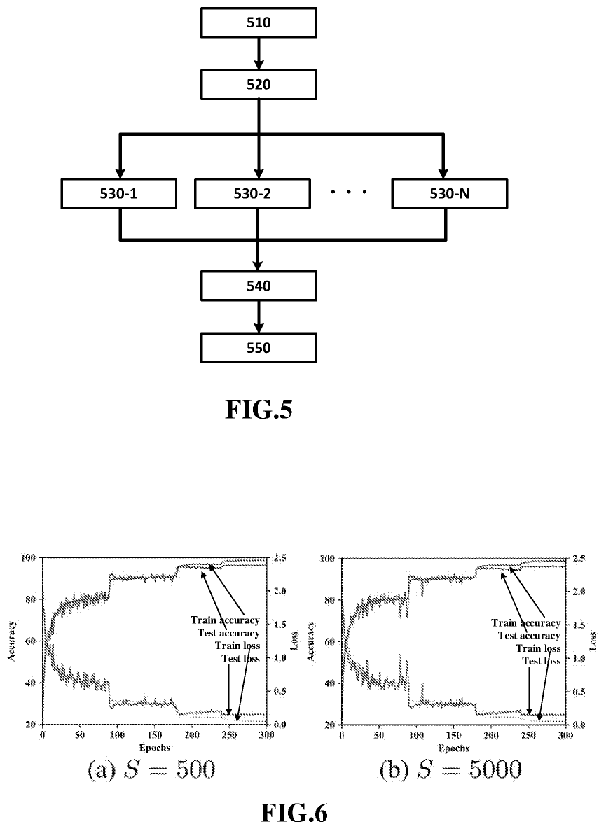

The inferencing may be performed using a trained weight sharing NSA. For example, the weight sharing NSA may be a task neural network trained for perform a specific task by the process illustrated above with reference to FIG. 2 or by the process illustrated below with reference to FIG. 5.

At step 310, an input data is received. In some examples, the task neural network may be configured to receive an input image and to process the input image to generate a network output for the input image, i.e., to perform some kind of machine learning task for image processing. For example, the particular machine learning task may be image classification and the output generated by the neural network for a given image may be scores for each of a set of object categories, with each score representing an estimated likelihood that the image contains an image of an object belonging to the category. As yet another example, the particular machine learning task can be object detection and the output generated by the neural network can be identified locations in the input image at which particular types of objects are depicted.

As another example, the inputs to the task neural network are Internet resources (e.g., web pages), documents, or portions of documents or features extracted from Internet resources, documents, or portions of documents, the particular machine learning task can be to classify the resource or document (“resource classification”), i.e., the output generated by the task neural network for a given Internet resource, document, or portion of a document may be a score for each of a set of topics, with each score representing an estimated likelihood that the Internet resource, document, or document portion is about the topic.

As another example, the particular task can be a health prediction task, the input is electronic health record data for a patient and the output is a prediction that is relevant to the future health of the patient, e.g., a predicted treatment that should be prescribed to the patient along with a score, the likelihood that an adverse health event will occur to the patient, or a predicted diagnosis for the patient along with a score.

As another example, the particular task can be an agent control task, where the input is an observation characterizing the state of an environment and the output defines an action to be performed by the agent in response to the observation. The agent can be, e.g., a real-world or simulated robot, a control system for automatic driving, a control system for an industrial facility, or a control system that controls a different kind of agent.

As another example, the inputs to the task neural network are features of an impression context for a particular advertisement, the output generated by the task neural network may be a score that represents an estimated likelihood that the particular advertisement will be clicked on.

As another example, the inputs to the task neural network are features of a personalized recommendation for a user, e.g., features characterizing the context for the recommendation, e.g., features characterizing previous actions taken by the user, the output generated by the task neural network may be a score for each of a set of content items, with each score representing an estimated likelihood that the user will respond favorably to being recommended the content item.

At step 320, one or more network architectures of the NSA are randomly selected. For example, each of the one or more network architecture is stochastically selected from the NSA with a uniform distribution or probability.

At step 330, one or more output data are inferenced by the selected one or more network architectures respectively based on the input data. For example, the selected one or more network architectures respectively process the input data to obtain the one or more inference outputs. The examples of the inference output by the network architectures for performing a particular task are illustrated above in the discussion of step 310, and would not be repeatedly explained here.

At step 340, a final inference data is obtained based on the one or more output data. For example, in the case of multiple inference outputs being obtained by multiple network architectures, the multiple inference outputs are ensembled to obtain the final inference data. For example, the multiple inference outputs are averaged to obtain the final inference data. For example, a voting may be performed based on the multiple inference outputs to obtain the final inference data.

It is appreciated that in existing NSA methods, the stochastic selection of a network architecture of a weight sharing NSA is only carried out during the training process. In the embodiment of the disclosure, through stochastically selecting one or more network architectures of a trained weight sharing NSA during the inference process, it may enhance the protection of network architectures from being attacked by utilizing the diversity of architectures of the NSA. Moreover, through ensemble of inference results from multiple stochastically selected network architectures of the trained NSA, it may enhance the accuracy and robustness of the trained neural network model.

FIG. 4 illustrates a graph comparing the accuracy and loss between training and testing according to an embodiment.

In the embodiment, the training is performed according to the method of FIG. 2 and the inferencing of the testing is performed according to the method FIG. 3. The loss value is computed based on the loss function shown in above discussed equation (2). The computation of the accuracy value may be formulated as:

$$( 3 )$$

$${A}_{ens} = \frac{1}{\vert {D}_{val} \vert} {\sum }_{( {x}_{i} , {y}_{i} ) ∈ {D}_{val}} ( arg {max}_{y} ( \frac{1}{T} {\sum }_{i = 1}^{T} p ( y \vert {x}_{i} ; w ; {α}_{i} ) ) = {y}_{i}$$

Where [symbol] ᵥₐₗ denotes the validation data set used in the test process, {αₜ}ₗ₌₁^{T} denotes the architectures stochastically selected from the trained NSA. It is appreciated that both the training data and the validation data includes the data pairs (xᵢ, yᵢ), and they are just used in different stages.

The graphs of FIG. 4 are obtained based on the typical CIFAR-10 image classification task. The size S the NSA is set as 500 and 5000 respectively. The accuracy and loss of every batch of data are calculated according to equation (2) and (3), and the average of the accuracy and loss is taken as the whole dataset accuracy and loss as illustrated in the graphs.

As shown in the graphs, there is a disparity between train accuracy and test accuracy and between train loss and test loss, which may be referred to as train/test disparity issue.

In order to alleviate the train/test disparity issue, a solution may be to explore the diversity of the stochastically selected network architectures during the training process of the NSA.

FIG. 5 illustrate an exemplary method for training a weight sharing NSA according to an embodiment.

The set up of network architecture space is similar as that explained above with reference to FIG. 2. The weight sharing NSA may be the refined architecture space including the sampled network architectures, or may be the whole architecture space in some embodiments.

The grouping of training data set in units of mini-batches is similar as that explained above with referent to FIG. 2. For example, the training data are divided into M mini-batches, each mini-batch contains N training data instances. The size of the NSA is S, that is, the NSA representing the refined architecture space includes S network architectures. In an embodiment, S is no less than 500. In an embodiment, S is no less than 500 and no larger than 5000. The weights of NSA may be initialized in any suitable way.

At step 510, one mini-batch is selected from the plurality of mini-batches, for example, one mini-batch is selected randomly from the M mini-batches, and the selected mini-batch includes N instances of training data.

At step 520, a plurality of network architectures are selected from the NSA for the selected mini-batch. For example, N network architectures A₁ to A_{N} may be randomly sampled from the S network architectures of the NSA with a uniform distribution or probability P(A), each of the N network architectures corresponds to one of the instances in the selected mini-batch. In the exemplary NSA as discussed above, each of the randomly selected network architecture A₁ to A_{N} includes 24 operation nodes connected in series and a set of bypass edges, each node including a ReLU-Convolution-BN operation triplet.

At step 530-1, a first one of the N instances of the selected mini-batch is applied to a first one of the selected network architectures to obtain a loss value. Similarly, at steps 530-2 to 530-N, each of the second instance to the Nth instance of the selected mini-batch is applied to one of the second to Nth network architectures respectively to obtain a loss value. The loss value for one instance based on one network architecture may be formulated as:

L=−log p(yᵢ|xᵢ;W,Aᵢ),Aᵢ˜p(A) (4)

where W denotes the weights contained in the network architecture, (xᵢ, yᵢ) denotes the instance of training data, for example, xᵢ denotes the data inputted to the network architecture, yᵢ denotes the data that is expected to be outputted by the network architecture, Aᵢ denotes one of the selected architectures. p(yᵢ|xᵢ; W, Aᵢ) is the predictive distribution, from which the loss value L=−log p(yᵢ|xᵢ; W, Aᵢ) is obtained. It is appreciated that although steps 530-1 to 530-N are illustrated as parallel processes, these steps can also be performed in one or more loops in which the steps are performed one by one.

At step 540, the N loss values for the N instances of the selected mini-batch are averaged to obtain a mean loss value over the mini-batch. Then mean loss value for one mini-batch may be formulated as:

$$L = \frac{1}{\vert B \vert} {\sum }_{( {x}_{i} , {y}_{i} ) ∈ B} - log p ( {y}_{i} \vert {x}_{i} ; W , {A}_{i} ) , {A}_{i} ∼ p ( A ) , i = 1 , … , \vert B \vert \qquad ( 5 )$$

where B denotes the selected mini-batch of training data, |B| denotes the number of instances included in the mini-batch, in this example |B| equals to N.

At step 550, the weights of the selected network architectures are updated based on the mean loss. Accordingly, the shared weights of the NSA are updated. For example, a first set of gradients for the weights contained in the architecture A₁ may be calculated by back propagating the mean loss for the mini-batch along the selected network architecture A₁, a second set of gradients for the weights contained in the architecture A₂ may be calculated by back propagating the mean loss along the selected network architecture A₂, and so on, a Nth set of gradients for the weights contained in the architecture A_{N} may be calculated by back propagating the mean loss along the selected network architecture A_{N}. Then the weights contained in the selected N network architectures may be updated using the N set of gradients. For example, each of the weights contained in the selected N network architectures may be updated using accumulative gradients for the weight. As another example, each of the weights contained in the selected N network architectures may be updated using an average of gradients for the weight. The shared weights of the selected network architecture include the weights for the operations contained in the network architecture and the weights for the edges contained in the network architecture. In the example that the ReLU-Convolution-BN operation triplet is used in the nodes, the shared weights include the weights for the convolution operations and the weights for the BN operations. The weights for the edges may be referred to as summation weights.

Then the process of steps 510-550 may be repeated for another mini-batch selected from the M mini-batches. The process of steps 510-550 may be repeated for M times for the M mini-batches of the training data set. The procedure for traversing the training data set by repeating the process of steps 510-550 for the M times may be referred to as an epoch. A plurality of epochs may be performed for the training data set until a convergence condition is obtained. For example, the convergence condition may be that the loss value is stable to be under a threshold.

Although N network architectures are selected for the selected mini-batch including N instances as illustrated in step 520, it is also applicable that less network architectures are selected for one mini-batch, for example, N/2, N/3 network architectures are selected for the on mini-batch while requesting that the number of the selected network architectures is larger than one.

Although the mean loss value is gradient based back propagated along the plurality of selected network architecture respectively to update the weights of the NSA, it is also applicable that the plurality of loss values are respectively gradient based back propagated along the plurality of selected network architectures to update the weights of the NSA.

FIG. 6 illustrates a graph comparing the accuracy and loss between training and testing according to an embodiment.

In the embodiment, the training is performed according to the method of FIG. 5 and the inferencing of the testing is performed according to the method FIG. 3. The loss value is computed based on the loss function shown in above discussed equation (5), and the accuracy value is computed based on the accuracy function shown in above discussed equation (3).

The graphs of FIG. 6 are obtained based on the similar conditions as the graphs of FIG. 4, except for the training process being different. Specifically, the typical CIFAR-10 image classification task is performed. The size S the NSA is set as 500 and 5000 respectively. The accuracy and loss of every batch of data are calculated according to equation (5) and (3), and the average of the accuracy and loss is taken as the whole dataset accuracy and loss as illustrated in the graphs.

As shown in the graphs, the disparity between train accuracy and test accuracy and between train loss and test loss in FIG. 6 is alleviated significantly comparing to that shown in FIG. 4.

According to an embodiment, in order to further explore the diversity of the stochastically selected network architectures of the NSA during the training process and inferencing process, extra weights of every network architecture of the NSA may be configured in addition to the shared weights of the NSA. The architecture specific weights may be low-dimensional in consideration of the computing and storing resource requirement. In an embodiment, weights for summation aggregations (i.e., the weights of edges) and weights for affine transformations in BN operations (i.e., the weights for BN operations) may be configured as the architecture specific weights. Accordingly, the weights other than the architecture specific weights may be configured as the shared weights of the NSA, for example, the weights of the convolution operations may be configured as the shared weights of the NSA in the example of ReLU-Convolution-BN operation triplet being used in the nodes. Therefore, in addition to a set of shared weights for all the network architectures of the NSA, S sets of architecture specific weights (e.g., affine weight and bias for BN, and summation coefficients for aggregation) are configured respectively for the S network architectures of the NSA. A set of architecture specific weights for one network architecture are updated only when the network architecture is selected at a training step as exemplarily shown in FIG. 2 and FIG. 5.

Go back to FIG. 5, in the embodiment having architecture specific weights configured, the set of shared weights and the S sets of architecture specific weights of the NSA are initialized before the step 510.

At step 510, one mini-batch is selected from the plurality of mini-batches, for example, one mini-batch is selected randomly from the M mini-batches, and the selected mini-batch includes N instances of training data.

At step 520, a plurality of network architecture is selected from the NSA for the selected mini-batch. For example, N network architectures A₁ to A_{N} may be randomly sampled from the S network architectures of the NSA with a uniform distribution or probability P(A), each of the N network architectures corresponds to one of the instances in the selected mini-batch. For each of the N selected network architectures, the shared weights contained in the network architecture come from the set of shared weights of the NSA, and the architecture specific weights of the network architecture are one of the S sets of architecture specific weights corresponding to the network architecture, therefore the shared weights contained in the network architecture and the architecture specific weights of the network architecture constitute the weights of the network architecture, or in other words constitute the network architecture.

At step 530-1, a first one of the N instances of the selected mini-batch is applied to a first one of the selected network architectures to obtain a loss value, where the first network architecture having shared weights and architecture specific weights. Similarly, at steps 530-2 to 530-N, each of the second instance to the Nth instance of the selected mini-batch is applied to one of the second to Nth network architectures respectively to obtain a loss value, where each of the second to Nth network architectures having shared weights and architecture specific weights. The loss value for one instance based on one network architecture may computed according to above equation (4).

At step 540, the N loss values for the N instances of the selected mini-batch are averaged to obtain a mean loss value over the mini-batch.

At step 550, the weights of the selected network architectures are updated based on the mean loss. For example, a first set of gradients for the weights (including the shared weights and the architecture specific weights) contained in the architecture A₁ may be calculated by back propagating the mean loss for the mini-batch along the selected network architecture A₁, a second set of gradients for the weights contained in the architecture A₂ may be calculated by back propagating the mean loss along the selected network architecture A₂, and so on, a Nth set of gradients for the weights contained in the architecture A_{N} may be calculated by back propagating the mean loss along the selected network architecture A_{N}. Then the weights contained in the selected N network architectures may be updated using the N set of gradients. For example, each of the shared weights contained in the selected N network architectures may be updated using accumulative gradients for the shared weight. Similarly, each of the architecture specific weights contained in the selected N network architectures may be updated using accumulative gradients for the architecture specific weight, and accordingly the N sets of the architecture specific weights for the N network architectures may be updated at this training step as exemplarily shown in FIG. 5. As another example, each of the weights contained in the selected N network architectures may be updated using an average of gradients for the weight. In an embodiment, the shared weights of the selected network architectures include the weights for at least part of operations contained in the network architecture, and the architecture specific weights of the selected network architectures include the weights for a part of operations and the weights for the edges contained in the network architecture. In the example that the ReLU-Convolution-BN operation triplet is used in the nodes, the shared weights include the weights for the convolution operations, and the architecture specific weights include the weights for the BN operations and the weights for the edges.

It is appreciated that the solution of the architecture specific weights may also be applied in the method shown in FIG. 2 in a similar way.

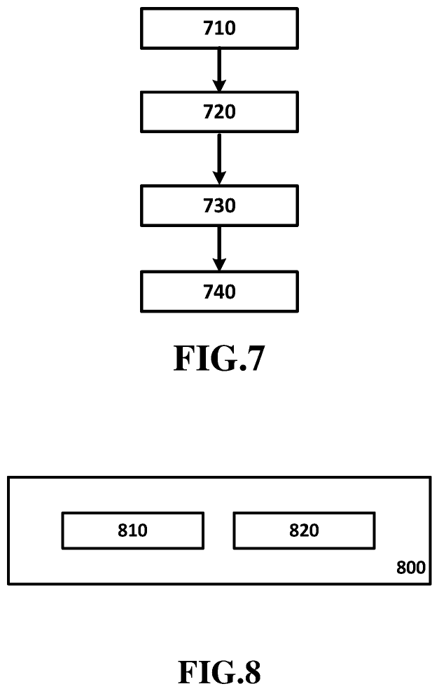

FIG. 7 illustrates an exemplary method for training a weight sharing network with stochastic architectures according to an embodiment.

At step 710, a mini-batch is selected from a plurality of mini-batches, where a training data set for a task being grouped into the plurality of mini-batches and each of the plurality of mini-batches comprising a plurality of instances.

At step 720, a plurality of network architectures of the neural network are stochastically selected for the selected mini-batch.

At step 730, a loss for each instance of the selected mini-batch is obtained by applying the instance to one of the selected plurality of network architectures.

At step 740, shared weights of the neural network are updated based on the loss for each instance of the selected mini-batch.

In an embodiment, the neural network comprises a set of nodes and a set of edges, each of the nodes representing at least one operation, each of the edges connecting two of the nodes, each network architecture of the neural network being represented as a directed graph of nodes connected by edges.

In an embodiment, the shared weights of the neural network comprise at least part of operations of the nodes. In an embodiment, the at least part of operations comprises convolution operations.

In an embodiment, gradients for the shared weights of the neural network are calculated by back-propagating mean loss of the loss for each instance of the selected mini-batch along the selected plurality of network architectures respectively or by back-propagating the loss for each instance of the selected mini-batch along a corresponding one of the selected plurality of network architectures respectively, and the shared weights of the neural network are updated by using an accumulation of the gradients for each of the shared weights.

In an embodiment, the neural network further comprises architecture specific weights for each network architecture of the neural network. The architecture specific weights for each of the selected plurality of network architectures are updated based on the loss for each instance of the selected mini-batch.

In an embodiment, the architecture specific weights for each network architecture of the neural network comprises at least one of: weights of edges of the network architecture, weights of a part of operations of the network architecture. In an embodiment, the part of operations comprises batch normalization (BN) operations.

In an embodiment, gradients for the architecture specific weights contained in the selected plurality of network architectures are calculated by back-propagating a mean loss of the loss for each instance of the selected mini-batch along the selected plurality of network architectures respectively or by back-propagating the loss for each instance of the selected mini-batch along a corresponding one of the selected plurality of network architectures respectively, and the architecture specific weights for each of the selected plurality of network architectures are updated by using an accumulation of the gradients for each of the architecture specific weights contained in the network architecture.

In an embodiment, the neural network comprises a main chain which comprises the set of nodes connected in series by edges, each network architecture of the neural network comprising the main chain.

FIG. 8 illustrates an exemplary computing system 800 according to an embodiment. The computing system 800 may comprise at least one processor 810. The computing system 800 may further comprise at least one storage device 820. The storage device 820 may store computer-executable instructions that, when executed, cause the processor 810 to select a mini-batch from a plurality of mini-batches, a training data set for a task being grouped into the plurality of mini-batches and each of the plurality of mini-batches comprising a plurality of instances; stochastically select a plurality of network architectures of the neural network for the selected mini-batch; obtain a loss for each instance of the selected mini-batch by applying the instance to one of the plurality of network architectures; and update shared weights of the neural network based on the loss for each instance of the selected mini-batch.

The storage device 820 may store computer-executable instructions that, when executed, cause the processor 810 to receive an input data; randomly select one or more network architectures of the neural network; infer one or more output data by the selected one or more network architectures respectively based on the input data; and obtain a final inference data based on the one or more output data.

It should be appreciated that the storage device 820 may store computer-executable instructions that, when executed, cause the processor 810 to perform any operations according to the embodiments of the present disclosure as described in connection with FIGS. 1-7.

The embodiments of the present disclosure may be embodied in a computer-readable medium such as non-transitory computer-readable medium. The non-transitory computer-readable medium may comprise instructions that, when executed, cause one or more processors to perform any operations according to the embodiments of the present disclosure as described in connection with FIGS. 1-8.

It should be appreciated that all the operations in the methods described above are merely exemplary, and the present disclosure is not limited to any operations in the methods or sequence orders of these operations, and should cover all other equivalents under the same or similar concepts.

It should also be appreciated that all the modules in the apparatuses described above may be implemented in various approaches. These modules may be implemented as hardware, software, or a combination thereof. Moreover, any of these modules may be further functionally divided into sub-modules or combined together.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein. All structural and functional equivalents to the elements of the various aspects described throughout the present disclosure that are known or later come to be known to those of ordinary skill in the art are expressly incorporated herein by reference and are intended to be encompassed by the claims.

1. A method for training a weight-sharing neural network with stochastic architectures, comprising:
selecting a mini-batch from a plurality of mini-batches, a training data set for a task being grouped into the plurality of mini-batches and each of the plurality of mini-batches comprising a plurality of instances;
stochastically selecting a plurality of network architectures of the neural network for the selected mini-batch;
obtaining a loss for each instance of the selected mini-batch by applying the instance to one of the plurality of network architectures; and
updating shared weights of the neural network based on the loss for each instance of the selected mini-batch.

2. The method of claim 1, wherein the neural network comprises a set of nodes and a set of edges, each of the nodes representing at least one operation, each of the edges connecting two of the nodes, each network architecture of the neural network being represented as a directed graph of nodes connected by edges.

3. The method of claim 2, wherein the shared weights of the neural network comprises at least part of operations of the nodes.

4. The method of claim 3, wherein the at least part of operations comprises convolution operations.

5. The method of claim 3, wherein updating the shared weights of the neural network based on the loss for each instance of the selected mini-batch further comprises:
calculating gradients for the shared weights of the neural network by back-propagating mean loss of the loss for each instance of the selected mini-batch along the selected plurality of network architectures respectively or by back-propagating the loss for each instance of the selected mini-batch along a corresponding one of the selected plurality of network architectures respectively; and
updating the shared weights of the neural network by using an accumulation or average of the gradients for each of the shared weights.

6. The method of claim 1, wherein the neural network further comprises architecture specific weights for each network architecture of the neural network, and the method further comprises:
updating the architecture specific weights for each of the selected plurality of network architectures based on the loss for each instance of the selected mini-batch.

7. The method of claim 6, wherein the neural network comprises a set of nodes and a set of edges, each of the nodes representing at least one operation, each of the edges connecting two of the nodes, each network architecture of the neural network being represented as a directed graph of nodes connected by edges.

8. The method of claim 7, wherein the architecture specific weights for each network architecture of the neural network comprises at least one of: weights of edges of the network architecture, weights of a part of operations of the network architecture.

9. The method of claim 8, wherein the part of operations comprises batch normalization (BN) operations.

10. The method of claim 8, wherein updating the architecture specific weights for each of the selected plurality of network architectures based on the loss for each instance of the selected mini-batch further comprises:
calculating gradients for the architecture specific weights contained in the selected plurality of network architectures by back-propagating a mean loss of the loss for each instance of the selected mini-batch along the selected plurality of network architectures respectively or by back-propagating the loss for each instance of the selected mini-batch along a corresponding one of the selected plurality of network architectures respectively; and
updating the architecture specific weights for each of the selected plurality of network architectures by using an accumulation or average of the gradients for each of the architecture specific weights contained in the network architecture.

11. The method of claim 2, wherein the neural network comprises a main chain which comprises the set of nodes connected in series by edges, each network architecture of the neural network comprises the main chain.

12. The method of claim 1, further comprising:
repeating the steps of claim 1 until all of the plurality of mini-batches have been selected for one time.

13. The method of claim 12, further comprising:
repeating the repeating step of claim 12 until a convergence condition is met.

14. A method for inferencing by using a weight-sharing neural network, comprising:
receiving an input data;
randomly selecting one or more network architectures of the neural network;
inferring one or more output data by the selected one or more network architectures respectively based on the input data; and
obtaining a final inference data based on the one or more output data.

15. The method of claim 14, wherein the neural network comprises at least one of: shared weights of the neural network, and architecture specific weights for each network architecture of the neural network.

16. The method of claim 15, wherein the neural network comprises a set of nodes and a set of edges, each of the nodes representing at least one operation, each of the edges connecting two of the nodes, each network architecture of the neural network being represented as a directed graph of nodes connected by edges.

17. The method of claim 16, wherein the shared weights of the neural network comprises at least part of operations of the nodes, and the architecture specific weights for each network architecture of the neural network comprises at least one of: weights of edges of the network architecture, weights of a part of operations of the network architecture.

18. The method of claim 14, wherein the neural network is trained by using the method of claim 1.

19. A computer system, comprising:
one or more processors; and
one or more storage devices storing computer-executable instructions that, when executed, cause the one or more processors to perform the operations of the method of claim 1.

20. One or more computer readable storage media storing computer-executable instructions that, when executed, cause one or more processors to perform the operations of the method of claim 1.
